(19) United States
(12) Patent Application Publication
(10) Pub. No.: US 2006/0260331 A1
(43) Pub. Date: Nov. 23, 2006

(54) TRANSPORTABLE PUMPING UNIT AND METHOD OF FRACTURING FORMATIONS

(75) Inventor: Mark T. ANDREYCHUK, Calgary, AB (CA)

Correspondence Address: SEAN W. GOODWIN, 222 PARKSIDE PLACE, 602-12 AVENUE S.W., CALGARY, AB, T2R 1J3, CA

(73) Assignee: Frac Source Inc., Calgary (CA)

(21) Appl. No.: 11/382,925

(22) Filed: May 11, 2006

(30) Foreign Application Priority Data
May 11, 2005 (CA) 2,507,073

(51) Int. Cl. F17C 9/02

(52) U.S. Cl. 62/50.2

(57) ABSTRACT

A high capacity pumper for liquefied gas incorporates multiple pumping systems distributed in a parallel arrangement and in opposing orientation on a transportable platform such as a trailer. Vaporizers incorporate a burner control system utilizing a primary set of burners operating a baseline and a secondary set of burners providing fine regulating control. A system for fracturing formations is now possible using a minimum number of components including the high capacity pumper, a coiled tubing rig and a source of liquefied gas. An improved manifold for a cryogenic plunger pump includes unions and angled connectors between a supply conduit and each of a plurality of pump heads.

### FIELD OF THE INVENTION

Embodiments of the invention relate to transportable units and systems for providing large volumes of pressurized inert gases, particularly nitrogen such as use in the petroleum industry and more particularly to trailer mounted nitrogen vaporization and pumping units.

### BACKGROUND OF THE INVENTION

In some industries there is a need for high volumes of pressurized gases. For example, in the oil and gas industry, it is known to use pressurized inert gases, such as nitrogen, for enhanced recovery of hydrocarbon resources such as through fracturing and stimulation of coal bed methane for production of natural gas from coal (NGC). Liquefied nitrogen is pressurized, vaporized to a gas and injected down a well at high pressure to hydraulically fracture a coal seam bearing the natural gas. Examples of NGC reserves are those located in western Canada. While the embodiments herein are described in the context of the oil and gas industry, other applications benefit from improvements in the art of providing high volumes of pressurized gases.

In the oil and gas industry, and conventionally, large liquefied-gas vaporization and pumping units have arrived on site, typically on skids or in multiple loads. The assembly and subsequent disassembly and transport of the units to other sites following completion of fracturing or stimulation processes is costly and highly labor intensive. In one effort to reduce costs and to attempt to improve transportability, pumper units on conventional flatbed trailers are known for supporting components including power plants, pumps and flameless or fire-heated heat exchangers for vaporization. Units of this design are sufficient for operations which require relatively low capacity nitrogen pumping, such as at 600 standard cubic meters per minute (scm). With the advent of the exploitation of NGC, the volumes of gases required (e.g. 1800 scm) for high pressure fracturing of the coal beds for enhancing production therefrom is beyond the capability of conventional pumper units.

Attempts to increase the volumetric capacity to meet the larger injection needs has typically resulted in heavy transportable units which exceed most weight restrictions on roads imposed by organizations such as state, provincial and federal Departments of Transportation, or which otherwise require special permitting. Such regulations vary depending upon the type of roadways available to access wellsite locations and whether said roadways are under the jurisdiction of municipal, provincial, state or federal governments.

Therefore, a plurality of conventional, lower-weight units are typically used to provide the nitrogen capacity demanded by existing fracturing and stimulation operations. The need for more units increases the manpower required to operate the units, thus adding to the already increased costs of providing additional expensive equipment.

Ideally what is required is a transportable nitrogen pumper unit which is capable of providing high capacity, high pressure vaporized nitrogen on site wherever large volumes of gas are required. Such units would be part of a system that requires a minimum number of personnel to operate and must be in compliance with transportation regulations in the greatest number of locations of wellsites.

### SUMMARY OF THE INVENTION

In one embodiment, a high capacity pumper for liquefied gas incorporates multiple pumping systems arranged on a transportable platform such as a trailer. The pumping systems are oriented in opposing relation on the platform for balancing the weight distribution. For example, each system can comprise a power plant coupled to a transmission which is coupled to a liquefied gas pump and which discharges pressurized liquefied gas to a vaporizer; all of which are physically arranged in series. Two such systems can be oriented in opposing directions on the platform for distributing the heavy power plants on the trailer. More preferably, both first and second pumping systems comprise an engine, a transmission, a pump and a vaporizer arranged parallel to one another and extending axially between the front and trailing ends of the trailer. The opposing orientation places the engine of the first pumping system adjacent the vaporizer of the second pumping system. More preferably, one of the pumping systems can be of a higher capacity through the use of a higher power engine and transmission coupled to a power splitter which drives two pumps delivering pressurized liquid to twinned vaporizers.

In another embodiment suitable for NGC operations, a single transportable nitrogen pumper, having a capacity of 1800 standard cubic meters per minute (scm) of nitrogen, implements two pumping systems having three cryogenic nitrogen pumps. Another embodiment can comprise a single transportable nitrogen pumper having a capacity of 2400 scm of nitrogen and which implements two pumping systems having a total of four cryogenic nitrogen pumps.

For example, an 1800 scm embodiment can comprise, in combination, first and second pumping systems arranged on a single trailer having a tridem axle group with 24 wheels. This might otherwise be called a 24 wheeler.

For the purposes of this description, the 24 wheeler represents any trailer having an equivalent regulatory capacity to a tridem axle group having 8 tires per axle for a total of 24 tires. For example, note that tires and trailers are becoming available which could incorporate a wide profile tire to replace dual tires and thus a “24 wheeler” herein could in theory include only 12 tires for supporting the same maximum allowable weight per axle as 24 conventional tires. Similarly, a 16 wheeler herein means conventional tandem axles having 8 tires per axle or equivalent.

Such an 1800 scm embodiment comprises a first pumping system having a 2250 HP engine which drives first pair pumps, being two 600 scm rated cryogenic liquefied gas pumps. The two pumps are driven through a single transmission and a power divider. The first engine, transmission, driveline and the first pair of pumps are aligned axially on the trailer and offset from a centerline thereof. The first pumps are fed liquefied nitrogen from a liquefied nitrogen source and deliver pressurized liquid nitrogen to one or more fluidly connected vaporization systems, such as burner heated heat-exchangers. A second pumping system comprises a second, 1500 HP engine which drives a second 600 scm pump. The second engine, transmission, driveline and second pump are aligned axially on the trailer and offset from the centerline. The first and second pumping systems are positioned side by side, substantially parallel and are oriented in opposing directions. In other words, the first engine is positioned at the opposite end of the trailer than the second engine. Preferably, the first pumping system utilizes two first heat-exchangers, positioned one over the other to fit the road width and height dimensions of the trailer having consideration for the second engine adjacent thereto and occupying the other side of the trailer. The heat-exchangers may be positioned relative to other ensure proper piping and exhausting of waste heat therefrom. In the particular embodiment, the first pair of heat-exchangers are located at the trailing end of the trailer laterally adjacent the second engine, all of which are positioned substantially over the tridem axles. Moving forward on the trailer, the first pumps are positioned adjacent and forward of the first heat-exchangers, the driveline including transmission and power divider gear box being forward of the pumps, and the first engine is adjacent the forward end of the trailer, substantially over the drive axles. Preferably, the drive axles are provided by tridem drive axles, such as that provided by a single or tandem steering axle, tridem tractor. Typically, such as depending on availability, equivalent drive arrangements might be employed including tandem drive axles or a tandem drive axles with an additional single axle jeep.

Accordingly, in this embodiment, the second pumping system utilizes a second heat-exchanger located adjacent the forward end of the trailer and beside the first engine. Moving rearwardly towards the trailing end of the trailer, the second pump is adjacent and rearward of the second heat-exchanger. The driveline extends rearwardly from the pump to the second engine located at the trailing end of the trailer, beside the two first heat exchangers.

The driveline or drivetrain can be of a variety of configurations dependent upon capacity and equipment manufacturer. For example, for a single engine driving two pumps, the driveline can comprise an engine coupled driveshaft to a remote transmission, a driveshaft to a single in dual out power divider, and dual driveshafts to the two pumps. For a lower power engine, the transmission and a torque converter might be integrated with the engine and a driveshaft from the transmission is directed to the single pump.

Therefore, in one embodiment a towed transportable pumping system for receiving liquefied gas and producing high pressure injection gas is provided comprising in combination: a towed trailer platform extending axially along an axis, the platform adapted for being supportably towed from a forward end and being supported upon a plurality of road-engaging wheels at a trailing end; a first pumping system having a engine and a first driveline drivably coupled to at least a first pump, the at least first pump, preferably a first pair of pumps, receiving liquefied gas and compressing the liquefied gas to an injection pressure and fluidly coupled with at least a first vaporization system receiving pressurized liquefied gas, vaporizing the liquefied gas and dispensing pressurized product gas, wherein the first vaporization system is positioned at the trailing end, and the first engine, the driveline and the first pair of pumps are arranged axially on the platform forward of the first vaporization system; and a second pumping system having an engine and a second driveline drivably coupled to at least a second pump, the at least second pump receiving liquefied gas and compressing the liquefied gas to an injection pressure and fluidly coupled with at least a second vaporization system receiving pressurized liquefied gas, vaporizing the liquefied gas and dispensing pressurized product gas, wherein the first pumping system is substantially parallel to and oriented in opposing alignment to the second pumping system.

In another embodiment, the above apparatus makes possible a low impact operation for fracturing subterranean formations with high rates of pressurized gas with a minimum number of components and a minimum impact on the environment.

In another embodiment, an improved manifold enables improved efficiency and improved ease of maintenance. More particularly, a liquid supply manifold has a plurality of connecters, one per pump head. Each connector is coupled at a union enabling one failed head to be removed without removing each other head. Further, each connector between the heads and the manifold can be oriented at an obtuse angle for aiding the flow of liquid from the manifold to the head.

In yet another embodiment, production of pressurized gas is managed using a vaporizer control system in which multiple burners of a heat exchanger are operated in at least two sets: a primary baseline set of burners which provide most of the heat required for the pumping rates, and a secondary regulating set of burners which provide fine control for temperature control.

### BRIEF DESCRIPTION OF THE DRAWINGS

FIG. 1 is an overall plan view of an arrangement of a system of well fracturing equipment according to an embodiment of the invention and including a rig, a pumper unit, and a tanker of liquefied gas;

FIG. 2A is a plan view of an embodiment of the invention illustrating a trailer and both first and second pumping systems and supporting components mounted thereon;

FIG. 2B is a left side view of the embodiment of FIG. 2A illustrating the trailer and both first and second pumping systems and supporting components mounted thereon;

FIG. 3 is a right side view of the embodiment of FIG. 2A illustrating the trailer and both first and second pumping systems and supporting components mounted thereon;

FIGS. 4A,4B are plan and left side views according to FIGS. 2A,2B, extraneous mounting equipment and the like being removed to illustrate positioning of the first pumping system and first vaporization system;

FIGS. 5A,5B are plan and left side views according to FIGS. 2A,2B, extraneous mounting equipment and the like being removed to illustrate positioning of the second pumping system and second vaporization system;

FIGS. 6A,6B are plan and left side views according to FIGS. 2A,2B, extraneous mounting equipment and the like being removed to illustrate positioning of the first and second pumps and respective vaporization systems; and

FIG. 7 is a right side view of the embodiment of FIG. 2A, extraneous mounting equipment and the like being removed to illustrate positioning of the first and second pumps and respective vaporization systems.

FIG. 8A is a schematic diagram of the vaporizer, burners and burner control for the liquefied gas vaporizers;

FIG. 8B is a chart demonstrating the stages use of sets of burners for baseline heat and regulating of heat thereabove;

FIG. 9 is a partial side view of a cryogenic pump having a manifold and manifold system according to one embodiment of the invention;

FIG. 10 is an exploded side view of a pump to manifold connector according to FIG. 9;

FIG. 11 is an assembled and partial cross-section of the clamp of the connector according to FIG. 10;

FIGS. 12-14B are various view of the manifold connector clamp, and more particularly,

FIG. 12 is an exploded side view of the clamp halves separated prior to assembly;

FIG. 14A is a side view of the clamp halves in a clamped position;

FIG. 14B is a top cross sectional view of the clamped, clamp halves of FIG. 14A.

### DETAILED DESCRIPTION OF THE PREFERRED EMBODIMENTS

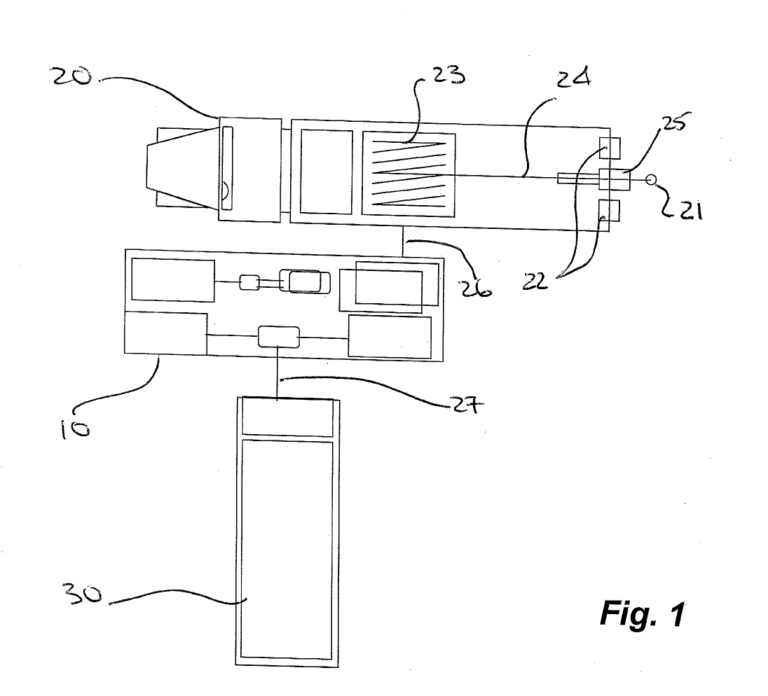

As shown in FIG. 1, a high-capacity liquefied gas pumper unit 10 can be part of a system utilizing a minimum number of components with a corresponding minimum impact on the environment and public. Fracturing of some forms of subterranean formations requires high capacities of pressurized gas. Heretofore, high capacity delivery systems suitable for NGC fracturing operations have requires two or even three separate pumper units to supply sufficient vaporized and pressured gas. The same can now be accomplished with one unit 10 according to the present invention. As discussed, one cannot merely use larger equipment as the limitation is the ability to legally deliver the heavy equipment over roads under a variety of conditions, and with minimum on site assembly. Ideally an entire on site operation is measured in hours and every lost moment is critical.

With reference to FIG. 1, the major components of a system according to an embodiment of the invention, such as that used for fracturing a formation, includes a coiled tubing rig 20 for accessing a wellhead 21 and delivering pressurized gases to a subterranean formation, the pumper unit 10, and a source of liquefied gas such as a tanker 30.

The rig 20 typically comprises a mast 22, a reel 23 of coiled tubing supplying coiled tubing 24 to an injector 25 in the mast and to the wellhead 21. A pressurized gas connection 26 is provided between the reel 23 and the pumper unit 10. The pumper unit 10 receives liquefied gas from the tanker via a liquid connection 27. The liquid connection 27 can include multiple conduits for delivery, return and recirculation as needed and as discussed below. The tanker 30 and pumper 10 are typically delivered to the site by tractor trucks (not shown).

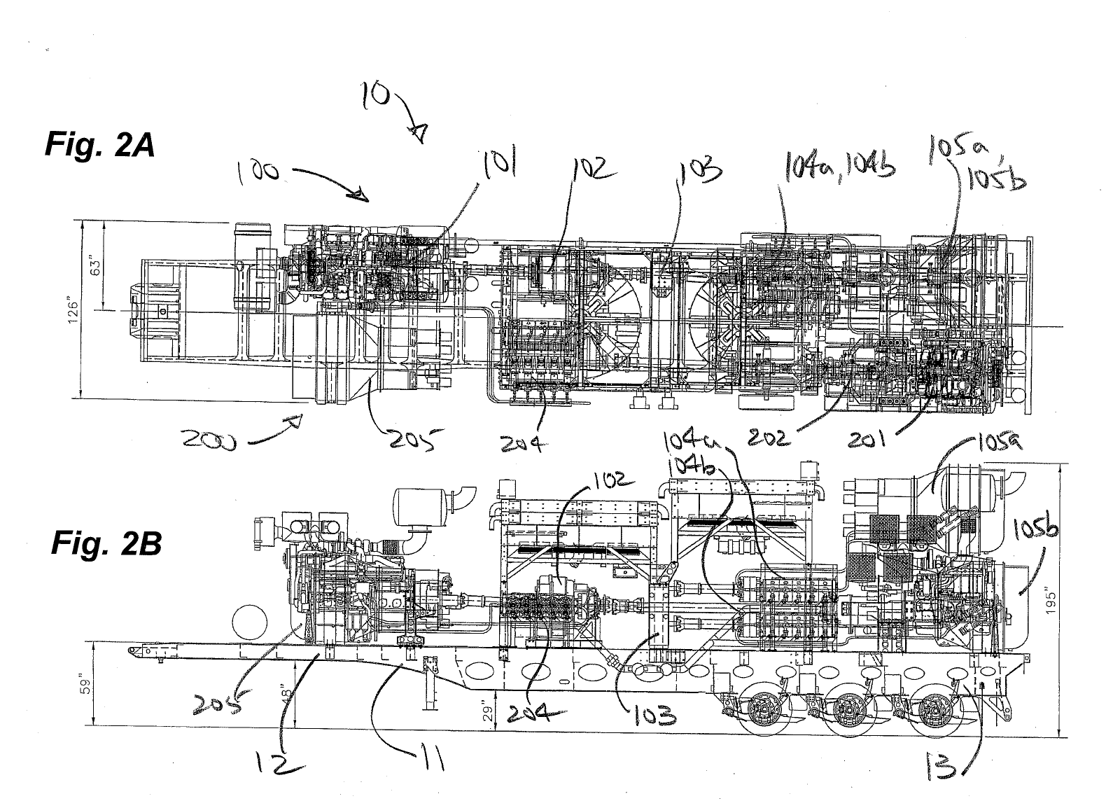

One form of the high capacity transportable liquefied gas pumper unit 10 is shown in FIG. 2A. This system is suitable for NGC fracturing operations at 1800 scm without the need for additional units. The weight and balance is such that the entire unit is roadable under virtually all transport requirements, maximizing its availability to the oil and gas industry. Similarly the unit is available for other industries where high volumes of pressurized gas are required including purging of pipelines and the like.

As shown, a three pump liquefied gas pumper 10 is provided on a single mobile frame. As shown, the frame comprises a tridem, 24 wheeler trailer 11.

While other liquefied gases could be used, nitrogen is most prevalent for oilfield use and fracturing. The high capacity nitrogen pumper trailer and the pumping components have a maximum weight and distribution suitable for travel on road under most conditions, according to the appropriate regulations. The trailer distributes the weight between trailing wheels at the trailer's trailing end 13 and the kingpin end or forward end 12. Typically, a tractor (not shown) for towing this embodiment of trailer would have a rear tri-drive tridem axle having 12 wheels at the pin and a single steering axle.

For example, Table A illustrates an example of weight distribution (kg) suitable under restrictive county roads in Alberta, Canada:

TABLE A

| | Tractor | | Trailer |
|---|---|---|---|
| | Steering | Drive axles | Equiv. 24 wheels |
| 100% Ban | 9100 | 21,000 | 34,000 |
| 90% ban | 9100 | 20,700 | 30,600 |

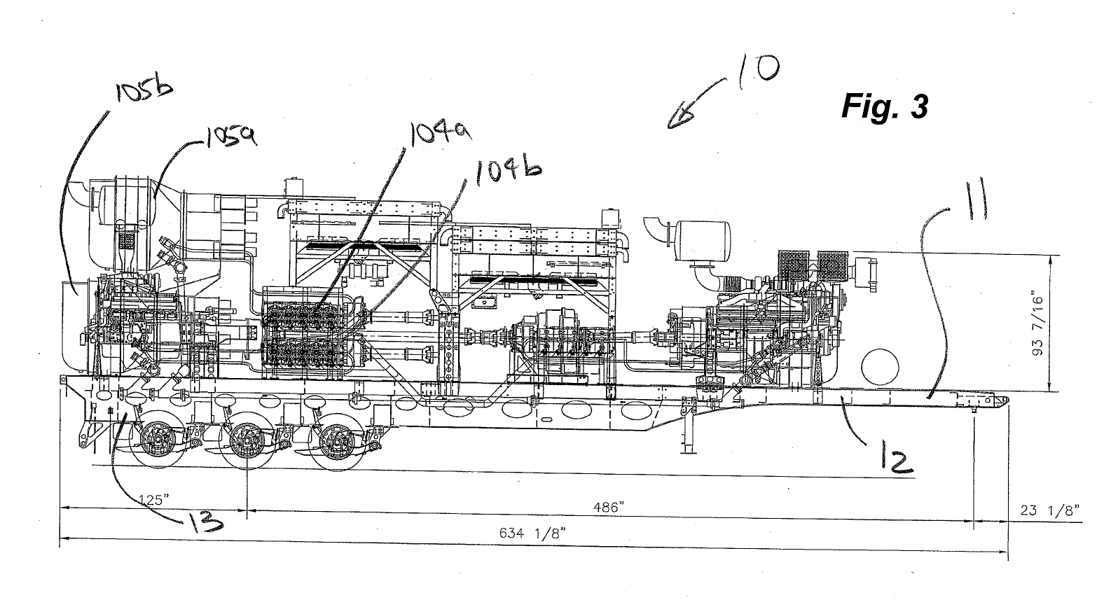

Having reference to FIGS. 2A, 2B, and 3 a first pumping system 100 is shown in parallel and opposing orientation with a second pumping system 200.

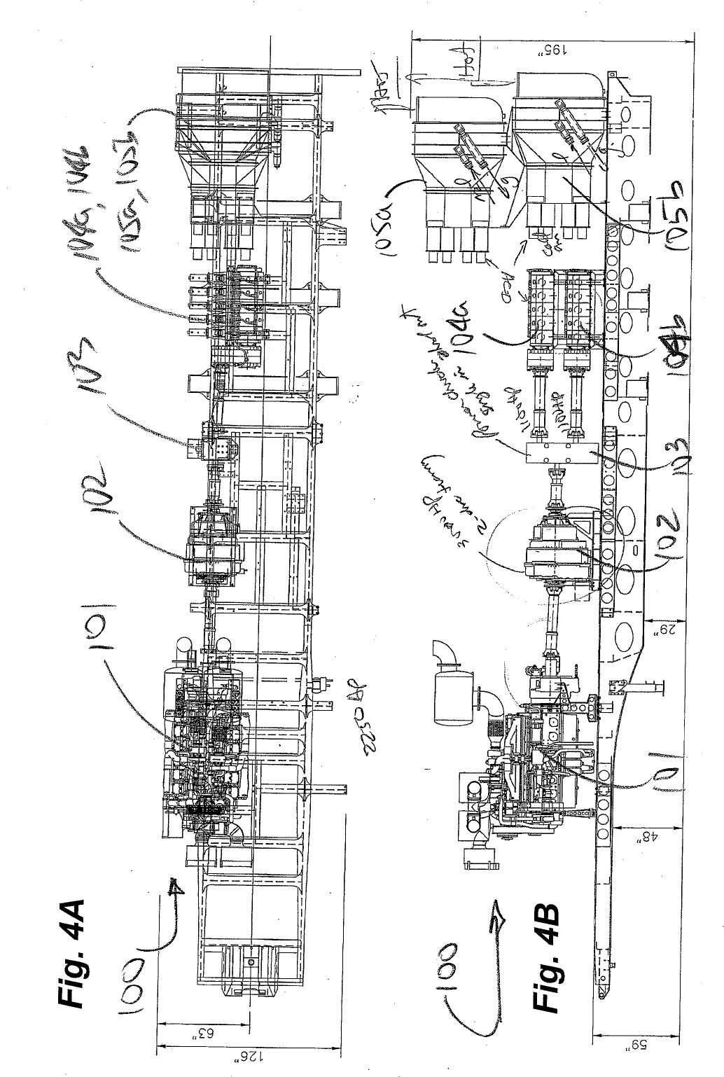

Referring also to FIGS. 4A,4B with the second pumping system 200 removed for clarity, the first pumping system 100 comprises a power plant or engine 101 such as a 2250 HP engine (such as a Cummins QSK45) coupled by driveshaft to a 3000 HP transmission 102. The transmission output drives a power divider 103 having dual output and driveshafts to drive a pair of first pumps 105a, 105b such as cryogenic 600 scm pumps (an example of each being a Quintplex™ pump, model ACD 5SLS 1500 HP, a Cryogenic Industries Company, Murietta, Calif., www.acdcom.com and www.cryoind.com.). The first pumps 105A,105B are fed liquefied nitrogen from an off-trailer source (not shown). Pressurized liquefied gas is fluidly connected to a first vaporization system comprising, in this embodiment using two, burner-heated heat-exchangers 105a,150b such as 1.2 million scfh burner boxes from ACD.

The first engine 101, driveline 102,103, the first pumps 105A,105B and vaporization systems 105a,105b are aligned axially on the trailer 11 from the forward end 12 to the trailing end 13 and are offset from the centerline.

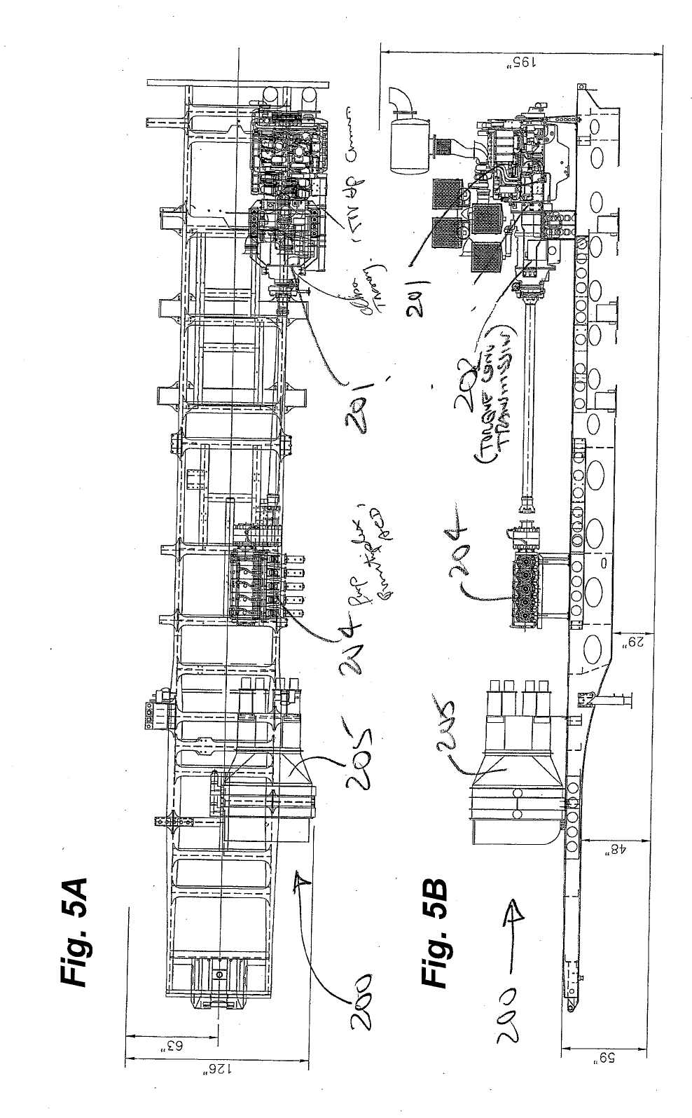

Similarly, and referring also to FIGS. 5A,5B with the first pumping system 100 removed for clarity, the second pumping system 200 comprises a power plant or engine 201 such as a 1500 HP engine (such as a Cummins QSK30) having a suitable engine-coupled transmission 202. The transmission output drives at least a second pump 204 such as an ACD cryogenic 600 scm pump. The second pump 204 is fed liquefied nitrogen from the off-trailer source. Pressurized liquefied gas is fluidly connected to a second vaporization system comprising a burner heated heat-exchanger 205.

The second engine 201, driveline 202, the second pump 204 and vaporization system 205 are aligned axially on the trailer from the trailing end 13 to the forward end 12 and are offset from the axis.

The first and second pumping systems 100,200 are positioned side by side, substantially parallel and are oriented in opposing directions. In other words, the first engine 101 is positioned at the other end of the trailer than the second engine 201. Advantageously, significant weight is over the trailing end 13 and distributed along the trailer 11 so as to obtain a distribution acceptable for trailering under various restrictive road conditions.

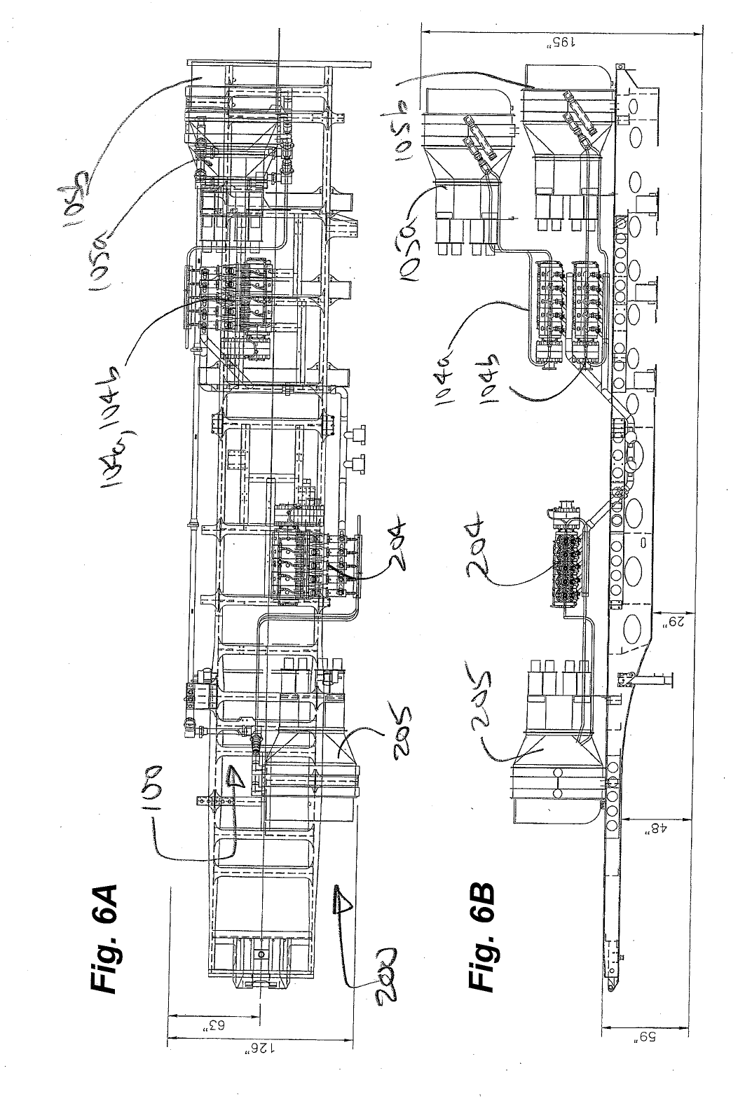

As shown in FIGS. 6A,6B and 7, preferably, there is at least a vaporization system (105a,105b),205 for each pumping system 100,200 respectively, and more preferably, a vaporization system 105a,105b,205 for each pump 105a,105b,204. In one embodiment, each vaporization system comprises a burner-fired heat-exchanger.

In the preferred embodiment the two heat-exchangers 105a,105b of the first pumping system 100 being positioned one on top of the other, the lower heat-exchanger 105b having structure manufactured to support the weight of the upper heat-exchanger 105a mounted thereon. Advantageously, heat may be transferred between the stacked heat exchangers, aiding in retaining the heat therein to more efficiently vaporize the liquefied nitrogen.

The second engine 201 is positioned offset from the platform axis and laterally opposing the stacked first heat-exchangers 105a,105b. The at least one second pump 204 is located about mid-platform, about adjacent the power divider 103 for the first pumping system 100.

The above system describes three pumps, two first pumps 105a,105b and one second pump 204. At 600 scm each, this embodiment of the nitrogen pumper would have a total capacity of 1800 scm.

While not shown, a 2400 scm pumper unit is available by adding a fourth pump and thereby employing a pair of second pumps driven by a power divider in an arrangement substantially identical to the first pumping system 100.

Opposing engine placement aids in reducing the effects of vibration and torque effects. Further, in the preferred embodiment of the first pumping system 100, a single gear box is used to drive the two first pumps. Advantageously, vibration, which normally occurs in the driveline due to momentary accelerations and decelerations as a result of resistance during initial plunger stroking, is cancelled out, the pumps being timed so as to be at substantially opposite ends of the stroke at any given time. The pumps, being mechanically linked, transmit any resulting (torsional?) force to one another rather than to the driveline, resulting in a cancellation of the vibration.

If required, and to further assist in ensuring balancing of the weight load of the entire unit, a hydraulic tank weighing up to about 2000 lb, and typically situated at the rear of the tractor used to tow the pumper unit trailer, is preferably moved to the front of the tractor and is attached as a counter balance at the tractors front bumper area.

Additionally, in the case of more restrictive road bans, the unit can be further supplemented with a jeep and booster (for providing a greater number of ground engaging wheels), ensuring that the nitrogen pumper unit can meet road regulations in the greatest number of situations where the unit might be required.

The source of liquefied gas such as nitrogen from tanker 30 and connection 27 to the pumper 10, can be conventional however, preferably, the present system further comprises improved transfer means for transferring the liquefied nitrogen to the pumper. From a vacuum insulated liquid source, liquid nitrogen is provided to the pumper at an excess rate so as to enable return to the source, the excess serving to ensure adequate supply of liquid to the pumps and to cool the pump heads. The liquid transfer lines are insulated and connections are streamlined to avoid temperature rise and eliminate agitation, eddies and cavitation issues. With vacuum-insulated transfer lines both on supply and return, vent losses from the liquid source are minimized.

Further, the transfer lines, conventionally being bellows-type hose, are lined to smooth the interior of the hose to reduce the boundary flow and associated turbulence therein and thus create a more laminar flow which is less subject to cavitation. Flow rates and the like are controlled by a conventional onboard flow control module.

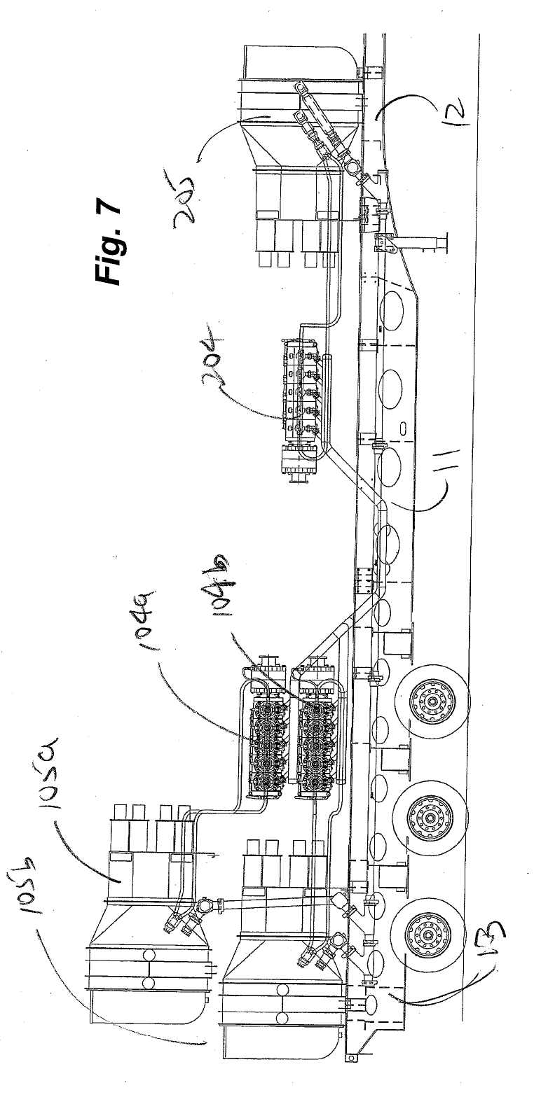

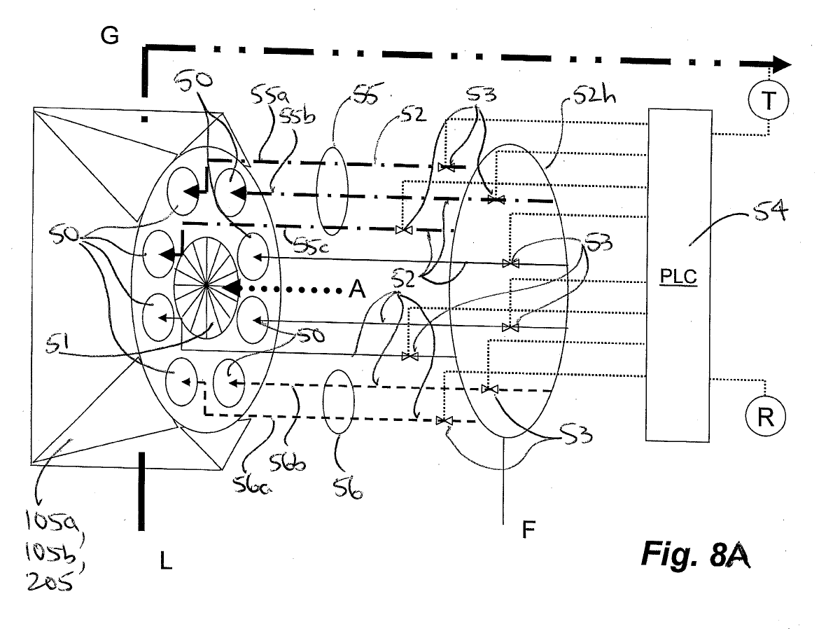

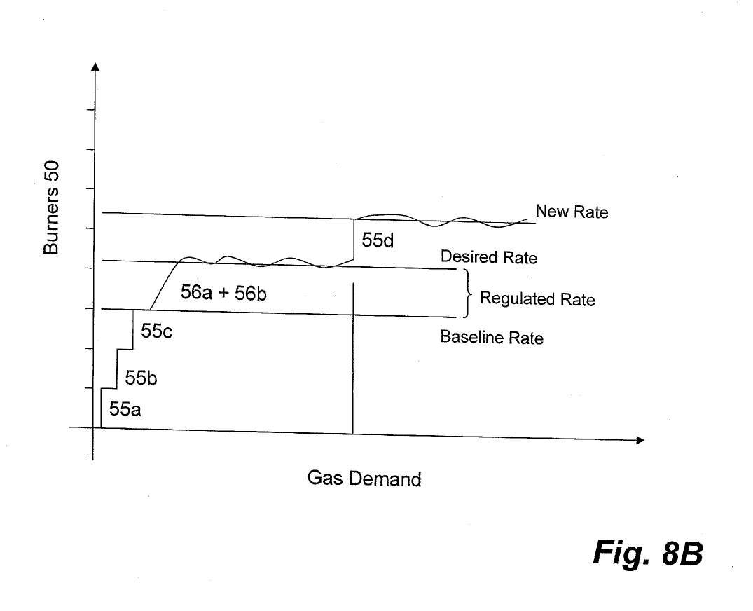

With reference to FIGS. 7 and 8A, the vaporization of the pressurized liquefied gas is controlled with a novel system for ensuring rapid and sure control of the flow rate of the delivered pressurized gas. For providing consistent and controllable heat to the vaporizer's heat exchangers 105a,105b,205 and for responding to changes in demand, a system of controlling burner output is provided. Contrary to known systems which regulate the low to high fire rates of burners all together, the present system implements a primary set of a pre-determined number of one or more baseline burners operating at optimal high fire rate, and a secondary set of a pre-determined number of one or more regulating burners. Other additional burners can be provided as required to be incorporated either into the primary or secondary set of burners if the heat demand changes.

In one embodiment, a vaporizer comprises a burner assembly eight diesel-fueled burners 50. Diesel is a common fuel for remote locations and oilfield services. While some burners are fit with their own air supply or fan, the illustrated vaporizer is fit with one common air supply or fan 51 for all burners 50. Each burner is fit with an ignition and pilot system (not detailed). The ignition and pilot systems are not detailed as they are well known to those in the art. Each burner 50 is also provided with a main fuel sully or fuel line 52 which is fit with a valve 53 such as solenoid for independent on/off control of fuel F such as from a pressurized header 52h to each burner 50.

A programmable logic controller (PLC) 54 is tied to a temperature sensor T and a rate of flow sensor R. The temperature sensor T measures the temperature related to the vaporized and pressurized gas G. The rate sensor R is related to the pumped flow rate including such as by pump strokes, engine speed or measured flow rate.

In operation, the burners pilots are on and the air fan or fans 51 are on. The pump 104a,104b, 204 is operated for producing a particular flow rate of pressurized liquid for delivery to the vaporizer 105a,105b,205. The heat required to vaporize a given rate of liquefied gas L to gas G is a known relationship. Variables such as vaporizer and burner efficiency and pump characteristics can be compensated for empirically or through process feedback. Accordingly, and with reference also to FIG. 8B, for a given desired rate of pressurized gas G, a first or primary set 55 of a pre-determined number of one or more baseline burners are operated at optimal high fire rate. For illustration purposes only, three baseline burners 55a,55b,55c of eight burners 50 are operated at high fire to provide most, but not all of the heat required to vaporize the liquefied gas.

For fine control of heat output, a second or secondary set 56 of a pre-determined number of one or more regulating burners are provided which are manipulated at a regulated rate between a low fire and a high fire rate to control at the desired heat rate. Similarly, for illustration purposes only, two regulating burners 56a,56b of the eight burners 50 are operated to control output temperatures of the gas G.

If there is a change in the demand, one or more additional burners 50 can be allocated to or removed from the primary set 55 or from the secondary set 56 of burners 50. In FIGS. 8A,8B, there are three additional burners 50 which have not yet been allocated. As shown in FIG. 8B, one additional burner 50 can be added as an additional baseline burner 55d, while regulating burners 56a and 56b continue to provide fine control at the desired heat rate.

The PLC 54 controls each valve 53 and thereby assigns or removes a burner 50 to either the primary set 55, the secondary set 56, or to remain on standby. Each burner 50 is already operating on its pilot and is ready for use upon the flue line being controlled to the on or off state. Based on engine speed or flow rate, and as dictated by a programmed relationship in the PLC, the PLC chooses one or more burners 50 to be primary burners 55a, 55b . . . and one or more remaining burners 50 to be secondary burners 56a, 56b, . . . typically pre-determined from a known relationship or empirical data. The PLC opens the appropriate vales 53 and fuel flows to the selected burners 50. The PLC adjusts the secondary set 56 as necessary to maintain the desired temperature T at in accordance with a given desired response. If the secondary set 56 begins to operate outside a desired band, then burners 50 can be added or subtracted from the primary set 55 or secondary set 56 as necessary.

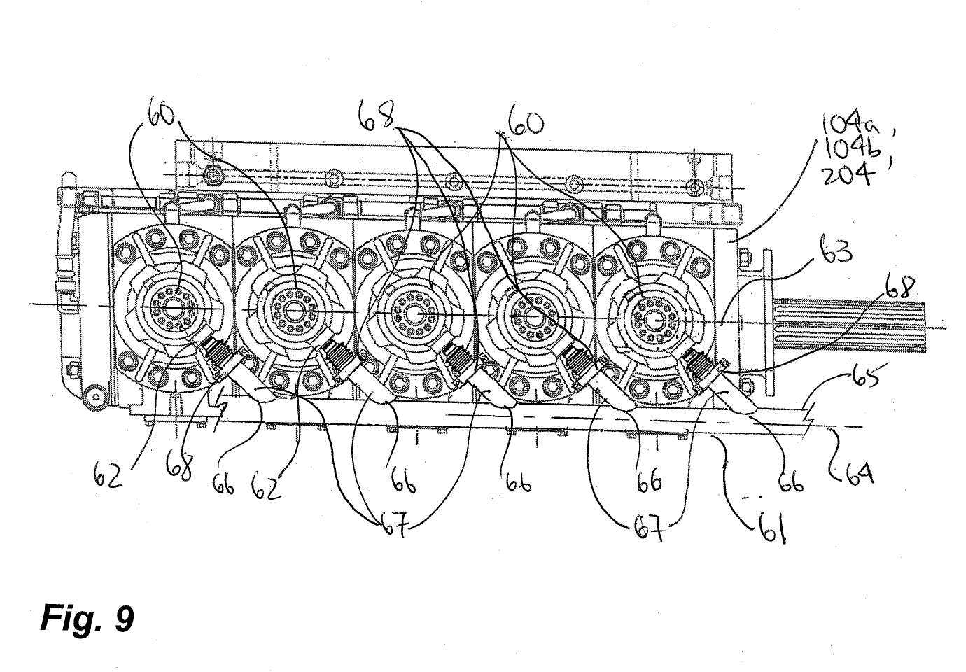

With reference to FIGS. 9 through 14B, in addition, the pumps 1041,104b,204 themselves are provided with an improved manifold system for a more efficient supply of liquid to two or more heads 60 of the pumps and which further facilitate ease of repair. Typically a head 60 of the two or more liquid plunger heads of a cryogenic reciprocating, positive displacement pump fails independently of each other head 60 and would be replaced or repaired one at a time, and not all at once. The heads 60 of the pump are generally placed in parallel arrangement, side by side and spaced closely together and thus, to avoid difficulties in removal of one head without time-consuming removal of adjacent heads, the improved manifold system employs connections that are easily removable or modular. The liquefied gas supplied to each head 60 is provided by a ganged liquid supply conduit or manifold 61. The particular Quintplex™ pump described above has five heads 60. Each of the five heads 60 has a side liquid inlet 62 supplied by the manifold 61.

Each of the two or more closely-spaced adjacent intake heads 60 are arranged side by side in a line 63. As shown, typically the heads are arranged in a line and oriented horizontally. The manifold has comprises a liquefied gas supply conduit having an axis 64 which is offset, usually below, and substantially parallel to the line 63 of heads 60,60 . . . . The supply manifold 61 has a liquid inlet end 65 and two or more liquid outlets 66, one for each head 60.

A liquid transfer conduit or connector 67 extends from each liquid outlet 66 in the supply manifold 61 to each side liquid inlet 62. Each connector 67 has a union 68 therein for enabling disconnection of one head 60 without disturbing the others 60,60 . . . .

The connector 67 has a first conduit section 70 extending from the head 60 and a second conduit 71 section extending from the supply manifold 61. The first and second sections 70,71 are releasably and sealably connected at the union 68. The first section 70 can be flexible and has a first end 72 adapted to be connected to the side liquid inlet 62 of the head 60, such as by a threaded connection, and a second end 73 fit with a first flare or flange 74, the first flange having a first sealing face. The second section 71 has a first end 75 fit with a second flare or flange 76 having a second sealing face for mating with the first flange 74 such as by a seal ring 77, and has a second end 78 connected to the supply manifold 61 such as by welded connection. While conventional face-to-face flanges 74,76 can be used, the overall dimensions of the connector 67 can be further minimized using a union such as a removable clamp 80 which couple the flanges.

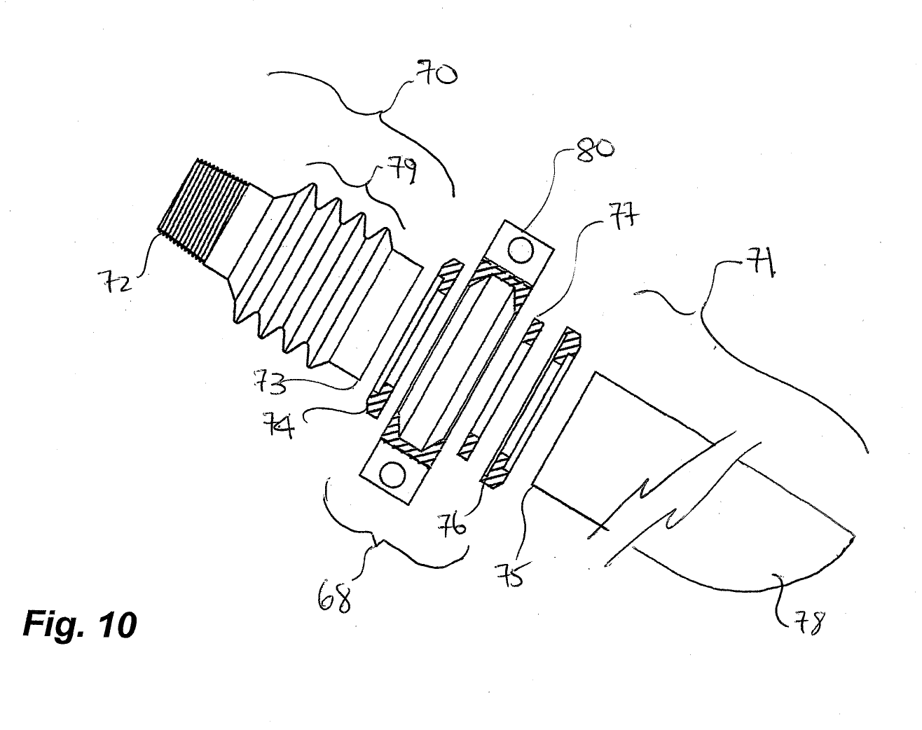

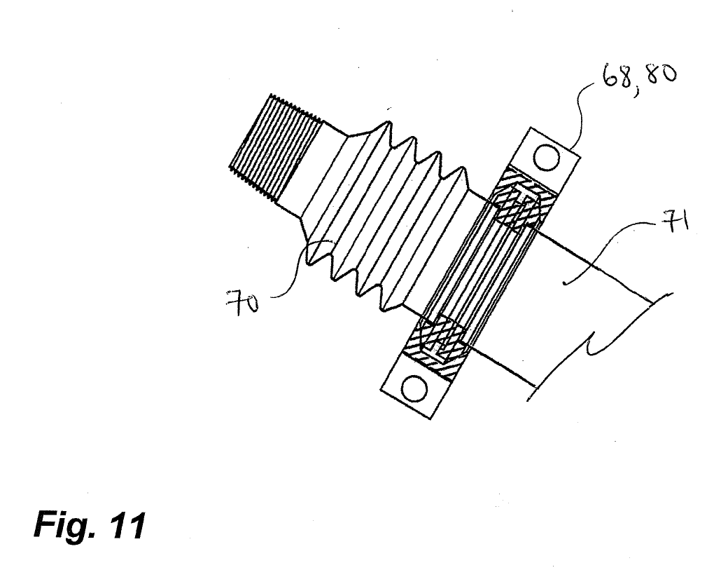

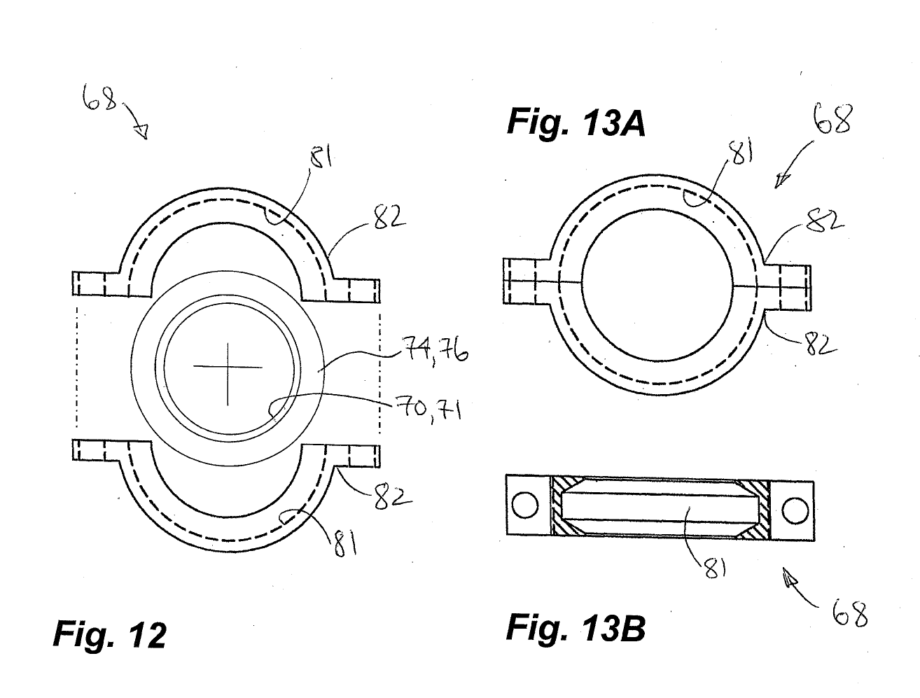

With reference to FIGS. 12-13B, such a clamp 80 includes an annular profile 81 which, in a first connected position, engages the first and second flanges 74,76 and which forces the first and second sealing faces into sealing engagement at seal ring 77 and, in a disconnected position, release the first and second flanges, wherein a head 60 and the flexible section 70 of one head 60 can be removed without a need for removal of adjacent heads 60,650 . . . . Further, the first section 70 could also be removed from the side liquid inlet 62 for additional mobility. The clamp 80 comprises opposing annular semi-circular pinch portions 82,82. Fasteners (not shown) draw the pinch portions 82,82 together for applying sealing loads to the flanges 74,76.

The first section 70 can include a flexible bellows portion 79 to enable limited manipulation of the first section and accommodated of manufacturing misalignment of the supply manifold 61 and the heads 60.

Referring again to FIG. 9, in another embodiment, each connector 67 of the manifold 61 is oriented at an obtuse angle, such as about 30 degrees, from the liquid source or inlet end 65 for lessening the abrupt transition of liquid flow to each head 60. The angle can vary as necessary to physically clear an adjacent head 60. The second section 71 is connected to the supply manifold 61 at this obtuse angle

The embodiments of the invention for which an exclusive property or privilege is claimed are defined as follows:

1. A system for receiving liquefied gas and delivering pressurized gas comprising:
a towed trailer having a towing end and a trailing end supported on ground-engaging wheels;
a first pumping system arranged along on the trailer between the towing end and the trailing end and comprising a first engine and one or more first pumps drivably coupled to the first engine;
a second pumping system arranged along on the trailer and substantially parallel to the first pumping system between the trailing end and the towing end and comprising a second engine and one or more second pumps drivably coupled to the second engine, the first and second pumping systems being opposingly oriented wherein the weights of the first engine and the second engine are spaced from each for weight distribution along the trailer; and
first and second vaporizers arrange adjacent each other and adjacent the trialing end of the trailer,
wherein the first and second pumping systems receive liquefied gas and deliver pressurized liquid gas to the vaporizers and wherein the vaporizers deliver the pressurized gas.

2. The system of claim 1 wherein the one or more first pumps comprise two or more first pumps arranged in parallel and having their liquefied gas inlet fluidly connected and having their pressurized liquid outlets fluidly connected.

3. The system of claim 2 further comprising a first driveline having a power divider intermediate the first engine and the two or more first pumps.

4. The system of claim 2 wherein the one or more pumps comprise two or more second pumps arranged in parallel and having their liquefied gas inlet fluidly connected and having their pressurized liquid outlets fluidly connected.

5. The system of claim 1 wherein the one or more vaporizers further comprise:
two or more burners and at least one sensor for establishing signals indicative of a change in demand for pressurized gas, and
a controller for operating at least one of the one or more burners at a baseline output and regulating at least one of the remaining one or more burners in response to the sensor for maintaining the flow of pressurized gas.

6. A mobile liquefied gas pumping trailer for towing behind a towing vehicle to a site and for delivering pressurized gases therefrom, comprising:
a frame having a towing end and a trailing end, the trailing end being supported by road-engaging wheels;
a first engine positioned towards the towing end, one or more first pumps positioned towards the trailing end and a first drive line extending drivably therebetween, the first pumps having a liquefied gas inlet and a pressurized liquid outlet;
a second engine positioned towards the trailing end, one or more second pumps positioned towards the towing end and a second drive line extending drivably therebetween, the first pumps having an inlet for receiving liquefied gas and an outlet for delivering pressurized liquefied gas;
at least one vaporizer for receiving the pressurized liquefied gas and delivering the pressurized gas.

7. The pumping trailer of claim 6 wherein the at least one vaporizer comprises first and second vaporizers,
the first vaporizer receiving the pressurized liquefied gas from the first pump;
the second vaporizer receiving the pressurized liquefied gas from the second pump; and wherein
the first and second vaporizers are located adjacent the trailing end.

8. The pumping trailer of claim 7 wherein:
the one or more first pumps comprise two or more pumps arranged in parallel and having their liquefied gas inlet fluidly connected and having their pressurized liquid outlets fluidly connected; and
the first driveline further comprising a power divider coupling the first engine to the two or more pumps.

9. A system for controlling the output of liquefied gas vaporizer comprising:
a heat exchanger having a liquefied gas inlet and a vaporized gas outlet;
a burner assembly for heating the heat exchanger and imparting heat to vaporize the liquefied gases, the burner assembly having two or more burners;
a first sensor for establishing a first signal related to the flow of the vaporized gas;
a controller for monitoring the first sensor and upon a change in the first signal evidencing a change in flow, controlling the two or more burners to add change burner capacity.

10. The vaporizer control system of claim 9 wherein at least a primary set of one or more burners is controlled to provide a baseline heat rate and at least a secondary set of one or more burners is controlled to regulate the heat rate.

11. The vaporizer control system of claim 10 further comprising a common air supply for all of the two or more burners; and wherein the air supply operates continuously and the fuel is alternately controlled on/off for allocating or removing a burner from the primary set.

12. The vaporizer control system of claim 10 further comprising a second sensor for establishing a second signal related to the pump rate and wherein the controller monitors the second sensor and upon a change in the second signal evidencing a change in demand controls the primary set of one or more burners to change the baseline heat rate.

13. The vaporizer control system of claim 11 wherein the first sensor is a temperature sensor.

14. A system for controlling the flow of vaporized gas in an operation for hydraulic fracturing of a formation in a wellbore comprising:
a source of liquefied gas;
a cryogenic pump for pressurizing the liquefied gas;
at least one vaporizer having
a heat exchanger having a pressurized liquefied gas inlet and a pressurized vaporized gas outlet;
a burner assembly for heating the heat exchanger and imparting heat to vaporize the liquefied gases, the burner assembly having two or more burners, each burner having a burner control for adjusting the heat output;
a first sensor on the vaporized gas outlet for establishing a first signal related to the flow of the vaporized gas;
a conduit for conducting pressurized gas between the vaporizer and wellbore; and
a controller for monitoring the first sensor and allocating at least one of the two or more burners as baseline burners and allocating at least one of the remaining two or more burners as regulating burners, wherein upon a change in the first signal evidencing a change in flow, controlling the regulating burners to maintain the flow of vaporized gas to the wellbore.

15. The system of claim 14 wherein at least a primary set of one or more burners is controlled to provide a baseline heat rate and at least a secondary set of one or more burners is controlled to regulate the heat rate.

16. The system control system of claim 15 further comprising a second sensor for determining the baseline heat rate.

17. The system of claim 16 wherein the controller monitors the second sensor and upon a change in the second signal evidencing a change in demand controls the primary set of one or more burners to change the baseline heat rate.

18. The system of claim 14 further comprising:
a common air supply for all of the two or more burners; and wherein the air supply operates continuously and the fuel is alternately controlled on/off for allocating or removing a burner from the primary set.

19. The system of claim 14 wherein the first sensor is a temperature sensor.

20. A method of controlling the flow of vaporized gas in an operation for hydraulic fracturing of a formation in a wellbore comprising:
pumping liquefied gas for delivering a pressurized liquefied gas;
delivering the pressurized liquefied gas to a vaporizer, the vaporizer having a heat exchanger and a burner assembly having two or more burners, each burner having an air supply and a fuel supply;
receiving pressurized liquefied gas at the heat exchanger and delivering pressurized vaporized gas therefrom;
sensing the temperature of the vaporized gas from the heat exchanger;
operating at least one of the two or more burners for maintaining a baseline flow of the vaporized gas;
monitoring the measures related to the flow of the vaporized gas and, upon a change in demand for pressurized gas,
controlling the burner assembly for the allocation or removal of one or more of the two or more burners to maintain the flow of vaporized gas to the wellbore.

21. The method of claim 20 wherein a primary set of one or more of the two or more burners are operated substantially continuously and wherein the burner assembly is controlled by regulating a secondary set of one or more of the two or more burners.

22. A system for accessing a formation through a wellhead and fracturing formations with high pressure injection gas comprising:
a first mobile platform having a source of liquefied gas;
a second mobile platform adapted for being supportably towed from a towing end and being supported upon a plurality of road-engaging wheels at a trailing end, the first platform comprising first and second pumping systems, each pumping system having a pump drivably coupled to an engine, the first and second pumping systems arranged parallel to one another and with their respective engines positioned adjacent opposing ends of the platform, and one or more vaporizers for receiving pressurized liquefied gas from the pumps and delivering a pressurized gas;
a third mobile platform having a coiled tubing injection system adapted for accessing the formation through the wellhead;
wherein when the first, second and third platforms are positioned at the wellhead, the second platform receives the liquefied gas from the first platform and delivers pressurized gas to the third platform for injecting the pressurized gas thereto.

23. The system of claim 22 wherein the one or more vaporizers of the second platform further comprise:
a burner assembly for heating a heat exchanger and imparting heat to vaporize the pressurized liquefied gases for forming pressurized gas, the burner assembly having two or more burners, each burner having a burner control for adjusting the heat output;
a first sensor for establishing a first signal related to a flow of the vaporized pressurized; and
a controller for
maintaining one or more of the two or more burners at a baseline heat rate, and
monitoring the first sensor and upon a change in the first signal evidencing a demand for additional flow,
regulating one or more additional of the two or more burners at for maintaining the flow of vaporized gas to the wellbore.

24. A manifold for a ganged inlet of a cryogenic pump having two or more closely-spaced adjacent intake heads arranged side by side in a line and each head having a side liquid inlet, the manifold comprising:
a liquefied gas supply conduit having an axis offset and substantially parallel to the line of heads and having a liquid inlet end, and
for each head;
a transfer connector extending from the supply conduit to the side liquid inlet of the head the transfer conduit having union comprising:
a first section having a first end connected to the side liquid inlet and a second end fit with a first flange, the first flange having a first sealing face,
a second section having a first end fit with a second flange and a second end connected to the supply conduit, the second flange having a second sealing face,
a clamp having an annular profile which
in a first connected position, engage the first and second flanges and force the first and second sealing faces into sealing engagement, and
in a disconnected position, release the first and second flanges, wherein a head and the flexible section of one head can be removed without a need for removal of adjacent heads.

25. The manifold of claim 24 wherein each connector is oriented at an obtuse angle from the inlet end.

26. The manifold of claim 24 wherein the first section is flexible.
